(19) United States
(12) Patent Application Publication
(10) Pub. No.: US 2011/0033093 A1
(43) Pub. Date: Feb. 10, 2011

(54) System and method for the graphical presentation of the content of radiologic image study reports

(76) Inventors: Donald E. Salz, New Rochelle, NY (US); Jeffrey B. Mendel, W. Newton, MA (US); Charles R. Hale, Trumbull, CT (US)

Correspondence Address: Woods Oviatt Gilman LLP, 700 Crossroads Bldg, 2 State St., Rochester, NY, 14614, US

(21) Appl. No.: 12/587,174

(22) Filed: Oct. 2, 2009

Related U.S. Application Data
(63) Continuation-in-part of application No. 12/535,825, filed on Aug. 5, 2009.

(51) Int. Cl. G06N 5/02; G06N 5/04; G06T 11/20; G06T 7/00

(52) U.S. Cl. 382/128; 706/54; 706/47; 345/440

(57) ABSTRACT

The present invention is directed in general to imaging technologies, and more specifically to a diagrammatic reporting methodology. A system and method are provided for graphically presenting the content of radiological image study reports. Even further, a system and method are provided for presenting the content of structured radiological reports including multiple imaging studies and their corresponding findings in a symbolic color-coded graphical diagram. Further still, the present invention may utilize an ontology of radiological knowledge to interpret report content to generate the information to be diagrammatically displayed in a symbolic color-coded graphical diagram.

### CROSS REFERENCE TO RELATED APPLICATIONS

This application is a continuation-in-part of prior U.S. patent application Ser. No. 12/535,825, filed Aug. 5, 2009. The content of U.S. patent application Ser. No. 12/535,825 is hereby incorporated by reference in its entirety.

### TECHNICAL FIELD

The present invention is directed in general to imaging technologies and more particularly to the reporting of radiological information. A system and method are provided for the graphical presentation of the contents of radiological image study reports. Even further, a system and method are provided for presenting the contents of structured radiological reports including multiple imaging studies and their corresponding findings in a single diagram. Further still, the present invention utilizes an ontology of radiological knowledge to interpret report content and generate information to be displayed in the graphical diagram.

### BACKGROUND OF THE INVENTION

In medical imaging, Picture Archiving and Communication Systems (PACS) are a combination of computers and/or networks dedicated to the storage, retrieval, presentation and distribution of images. While images may be stored in a variety of formats, the most common format for image storage is Digital Imaging and Communications in Medicine (DICOM). DICOM is a standard in which radiographic images and associated meta-data are communicated to the PACS system from imaging modalities for interaction by end-user medical personnel.

Medical personnel spend a significant amount of their time addressing administrative tasks. Such tasks include, for example, documenting patient interaction and treatment plans, preparing billing, reviewing lab results, recording observations and preparing reports for health insurance. Time spent on performing such tasks diminish the time available for patients and in some instances lead to inaccurate and hastily compiled reports or records when personnel are faced with the need to see multiple patients. Furthermore, the proliferation of systems and tests have also led to more extensive reports, patient histories and patient records.

In order to address time deficiency issues, the current trend in the medical field is to automate as many health care related processes as possible by leveraging various technologies, and thereby freeing up personnel to spend more time with patients rather than performing administrative tasks. Another objective in this arena is to ensure that administrative tasks are accomplished in an accurate and consistent manner. One approach to achieving this objective is to provide a robust and complete presentation of relevant healthcare related data, particularly within the various specialty areas such as radiology, cardiology, etc.

The presentation or representation of health care data is currently quite disjointed, requiring a review of multiple pieces of information or reports pertaining to a single patient. There is currently no cohesive overview that can provide detailed information at a level that would be easy to comprehend and provide sufficient detail to a medical reader. The most significant of these limitations being in the field of radiology.

Currently, some systems provide studies, dates and modalities, but the information is presented in a linear textual report. Other systems provide a simple study timeline, with no real report content. These systems continue to be limited in their ability and features due to the inability to support radiological findings, the relationships between findings and the characteristics of the findings. To overcome some of the deficiencies earlier described, some existing systems have attempted to minimize the amount of effort that may be required to report on radiological findings. However, these systems suffer from a myriad of drawbacks. Essentially these solutions have an inconsistent view of report content, and necessitate reader viewing and correlation of multiple text reports which can be quite tedious and cumbersome.

Presently, no systems are available to capably present in a graphical format, patient information that includes time and date, study types, evolution of findings and the significance of findings. What is needed is a system and method for graphical presentation of the content of medical reports. Such a graphical diagram may utilize an ontology that is domain specific in order to process domain specific report information.

Ontology is a data model for the modeling of the concepts and the relationship between a set of concepts. Ontologies are utilized to illustrate the interaction between a set of concepts and corresponding relationships within a specific domain of interest. Thus, the concepts and the relationships between the concepts can be represented in readable-text or graphics, wherein descriptions may be provided to describe the concepts within a specific domain, and the relationship axioms that constrain the interpretation of the domain specific concepts.

The limitations and lack of functionality present in currently available report systems and tools necessitate a comprehensive system that is capable of providing structured reports. Such structured reports would represent study types, date of studies, findings, follow-up recommendation or conclusions as an a-priori set of concepts, concept values and relationships, thus enabling the content of radiological reports to be easily analyzed. Further still, a graphical presentation of report content rather than a textual one eliminates the need for the reader to read a prose text report content and makes the report more easily and quickly comprehensible. This is particularly the case in the field of radiology, and even more specifically within the various domains therein, such as mammography.

The shortcomings of the prior art are overcome and additional advantages are provided through the provision of a method for report content presentation that is based upon data obtained from any data representations including unstructured, semi-structured knowledge sources, and radiological domain ontology. The application of the radiological domain ontology further provides identification, validation and classification of radiological concepts presented by the present invention.

The present invention fulfills these needs as well as other needs.

### SUMMARY OF THE INVENTION

The present invention is directed in general to imaging technologies, and more particularly, to the reporting of radiological image studies in a graphical diagram. In one aspect, a method is provided in a computing environment for graphically presenting aspects or attributes and contents of a patient's records. The records include varieties of image study reports. The method of the present invention comprises:
a. obtaining textual reports of the patient's studies;
b. performing an analysis of said textual reports to provide a structured report that identifies and classifies said textual reports' content by representing said textual reports' content as sets of concepts, concept values and relationships;
c. analyzing said structured report; and
d. presenting the result of the analysis of said structured report in a single graphical diagram.
   The structured textual reports comprise: an identification of the types of studies; a timestamp for when said studies were performed; findings from said studies; impressions; and follow-up conclusions.

In another aspect, the present invention employs radiological domain ontology to specify and model radiological image study report information as knowledge. The present invention provides a methodology to consult the domain ontology and provide information in reference to a report or images that may be specific to one or more than one modality.

In yet another aspect, the present invention provides a user with a view of significant aspects of the entire record of a patient in a single graphical presentation. For example, a finding that persists across multiple studies over time is clearly identified and easily perceived as such in the diagrammatic presentation. The information in the diagrammed presentation may be obtained from a variety of data representations including ontologies.

In an even further aspect, the present invention provides a graphical indication of the clinical significance of image study report findings.

### BRIEF DESCRIPTION OF THE DRAWINGS

The patent or application file contains at least one drawing executed in color. Copies of this patent or patent application publication with color drawings will be provided by the Office upon request and payment of the necessary fee.

The above-mentioned features and other features and advantages of this invention, and the manner of attaining them, will become apparent and be better understood by reference to the following description of the invention in conjunction with the accompanying drawing, wherein:

FIG. 1 is an exemplary prose text timeline of multiple radiological image studies for a patient;

FIG. 2 is a data and flow chart of exemplary steps for an implementation of the present invention of converting a text report to a graphical diagram;

FIG. 3A is a graphical representation of multiple radiological image studies presented according to the system and method of the present invention;

FIG. 3B is a key of meanings for the graphical presentation shown in FIG. 3A;

FIG. 4 is a block diagram generally illustrating a computing environment in which the present invention may be implemented;

FIG. 5 is an alternate exemplary colored graphical screen presentation of imaging and clinical information for a patient;

FIG. 6 illustrates a legend for interpreting the graphical presentation of FIG. 5;

FIG. 7 illustrates an alternative legend of symbols that could be utilized to present mammogram information;

FIG. 8 illustrates details that may be conveyed in the mammogram information symbol of FIG. 7;

FIG. 9 illustrates yet another set of symbols that may be utilized in another embodiment of the present invention; and

FIG. 10 illustrates a variation on the graphical representation of FIG. 5.

### DETAILED DESCRIPTION OF THE INVENTION

Generally, the system and methods described herein may be implemented in hardware, software or a combination thereof. The disclosed embodiments are intended to be illustrative since numerous modifications and variations thereof will be apparent to those of ordinary skill in the art.

This document is organized as follows. In the first section, an overview of the techniques and implementation necessary to provide a graphical representation of radiological report contents in accordance with the present invention is provided and described. As would be appreciated by one skilled in the art, while the present invention is described with reference to radiological image study reports, the invention would be applicable to other textual reports and other fields. In the next section, an exemplary prose text to which the present invention may be applied is described, followed by a description of some exemplary steps that may be involved in analyzing and converting said text into a structured report. Next an exemplary graphical representation of a report's content is described along with a legend that identifies the objects, symbolism, and colors utilized in the graphical diagram. Following this, other aspects of the invention as they pertain to use and function of the invention are discussed. Finally, an exemplary computer environment for the implementation and use of the invention is described.

In this described embodiment, the present invention employs radiological domain ontology to specify and model textual report content as knowledge. A system and method are provided to allow for consulting structured radiological image study reports in the context of the model the ontology fulfills. Consulting the ontology results in identified, validated and classified radiological report items that are based on the information provided in the textual report. The radiological report items may then be presented in a graphical diagram.

Furthermore, the present invention also relates to a solution for the extraction of information from an unstructured knowledge source or any other data representations. A set of subject-matter specific relationships may be established as a logical foundation for an ontological subject matter domain. The subject-matter specific relationships may be derived partially from a pre-existing information source (e.g., RadLex the radiological lexicon) and partially from the knowledge that needs to be modeled for an identified subject.

For example, ontology on the subject of mammography will use lumps or masses as topic concepts. The relationships may correspond to disease-specific relationships such as biopsy, additional exam, symptoms, location, further treatments, etc. Once the subject-matter specific relationships have been established, the unstructured knowledge source may be parsed in order to identify topic headings and content reference that is associated with respective topic headings within the unstructured knowledge source. The context texts/references that are identified within the unstructured knowledge source correspond to the predetermined subject-matter specific relationship. It should be understood that the source of the unstructured information is varied and may include such sources as spoken words, a user's typing, reports, or systems or applications that have patient information.

The content text, or in this implementation, the image study report content (finding) is then analyzed to identify references to concepts—wherein concept reference descriptors (finding characteristics) can be obtained and presented to a system user or to other down-line applications or systems. For each concept reference descriptor that is identified, an analysis is performed of relevant textual content information to identify references to concept descriptors that exist within the textual content information.

As previously mentioned, the present invention may utilize ontology to define a set of knowledge and relationships among the knowledge thereby employing a context. For example, if there is a screening mammography documented in the report, the system knows what other information would be relevant to that finding such as time and date of the study, follow-up recommendations, and the clinical significance of the finding and other characteristics that apply to that finding, as well as the relationships between the findings and finding characteristics.

Ontological models are used to talk about “things.” An important vocabulary tool is “relations” between things. An ontology model itself does not include the “things,” but introduces classes and relations, which can then be used as a vocabulary for talking about and classifying things. In the field of medicine, ontology is used in solving problems in medical terminology, including the organization of copious amounts of data, the alignment and integration of heterogeneous knowledge, and disambiguate terminology. Hence, the advantage of such an implementation in the present invention.

In an embodiment of the present invention, the radiological domain ontology is constructed using combinations of one or more of the following World Wide Web Consortium standards:

RDF—Resource Description Framework

RDFS—RDF Schema

OWLDL—Web Ontology Language Description Logic version

Although the following discussions and the present invention are described in relation to a biological imaging system, it should be understood that the invention is also applicable to other information/imaging technologies, systems or text reports.

Imaging systems as discussed herein, include those wherein image manipulation, image attributes, and features of an imaging system are required to be intuitively and easily analyzed and/or reported, including non-medical systems, visual analysis and diagnostic tools, and other visual user interface environments. Further, the present invention is described with reference to mammography and particular imaging modalities. However, the system and method of the present invention is equally applicable to other radiological domains and imaging modalities. Additionally, this specification describes and references structured radiological reporting for illustrative purposes only. The use in other applications or by other systems or tools are anticipated and within the scope of the present invention.

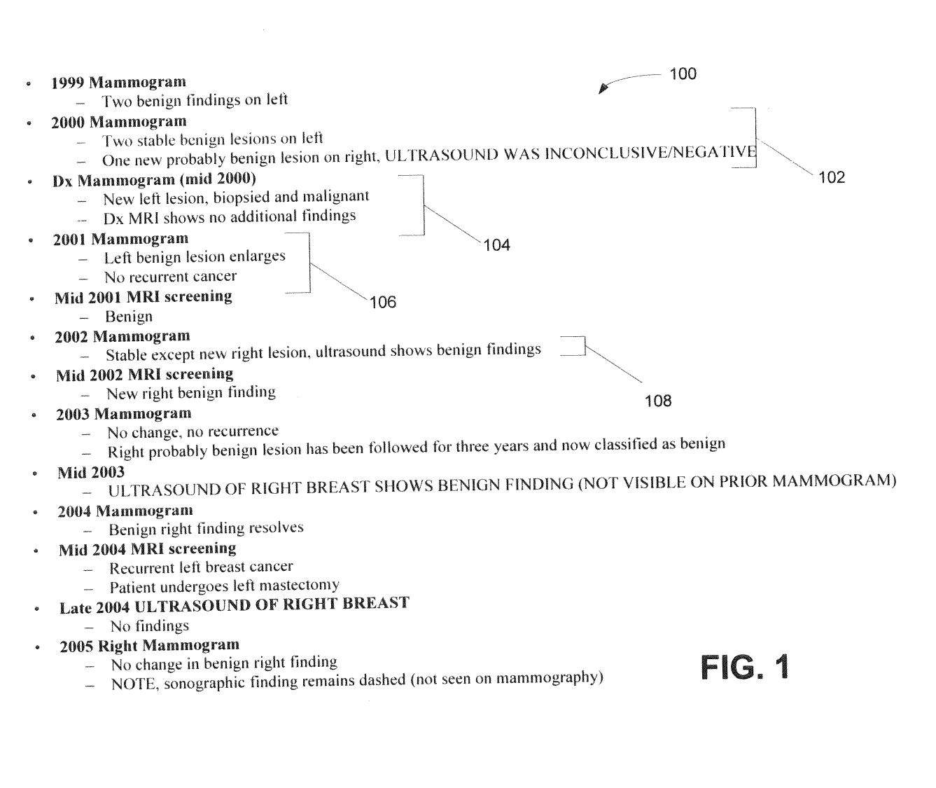

In an exemplary field of application of the present invention, a radiological report timeline of multiple radiologic imaging studies may be provided as shown in FIG. 1.

Referring therefore to FIG. 1, a history of imaging studies between the period of 1999 and 2005 generally referenced as report 100, is shown for an individual patient. As shown, certain study types are specified such as Mammogram, MRI Screening, or UltraSound. For any one or more of the study types there could be one or more images. In connection with a particular image that is being observed or considered by a radiologist, there may be a number of findings. Associated with the findings are typically a number of descriptors. The descriptors for any one of the findings may include, radiological comments, and the anatomical location of any findings. The descriptors may be part of the information conveyed in the timeline report 100. As would be appreciated by one skilled in the art, other information that would be pertinent to a reviewing radiologist and other medical personnel may also be included in the report 100.

To illustrate, consider a study in the year 2000 designated as study 102, of the timeline report 100. In the early part of the year, a mammogram was performed. As a result of the mammogram, two benign and stable lesions were found in the left breast of the subject patient. In the right breast, a new lesion which the radiologist assumes may be benign is also discovered. It further appears from the report that as a follow up to the discoveries, an ultrasound was conducted. The result of the ultrasound is reported as inconclusive or negative.

In mid 2000, a diagnostic mammogram, designated as study 104, was performed. This round of mammogram uncovered a new lesion in the left breast. The lesion was biopsied and concluded to be malignant. A diagnostic MRI was also conducted and it provided no additional findings.

These varied studies continue over several years with varying study types, findings, follow-ups, etc. As would be appreciated by someone viewing the report 100, it is cumbersome to keep track of what occurred when and what correlations or relationships might exist between the various studies and findings. The situation gets worse particularly as one considers events from one year or period to the next. The timeline report 100, while presented as a summary, is difficult to read, comprehend, and quickly analyze or interpret.

As a radiologist reviews the report 100, it becomes apparent that the information provided therein is described in a varied and arbitrary manner. For example, in 2001 when a mammogram study 106 was performed, a description of “no recurrent cancer” is provided in the report. This description is inconsistent relative to what was provided for the year 2000. Specifically, the question arises about whether all the cancerous lesions are gone. In another instance, in the mammogram of 2002, study 108, the finding is reported as “Stable except new right lesion, ultrasound shows benign findings.” This description of the finding is unclear. This finding could potentially mean that both the left and right breast conditions were stable. Furthermore, it is also unclear if the ultrasound benign findings apply to one or both breasts. In other words, the report is open to multiple interpretations. This would mean more time spent by a reviewing radiologist to perhaps dig into the details of the studies or images in order to get a clear picture. This lack of clarity is also symptomatic of the inconsistent phraseology or syntax that may be found in textual reports.

In order to comprehend the report 100, a person must read and understand the report text. In cases where a patient has had multiple imaging studies over time, the reader must read and correlate multiple, and perhaps inconsistent, reports such as described earlier. The detriment of these requirements are clearly obvious. According to an embodiment of the present invention, the report 100 provides content that would ultimately be structured for accuracy and consistency and then presented in a graphical diagram.

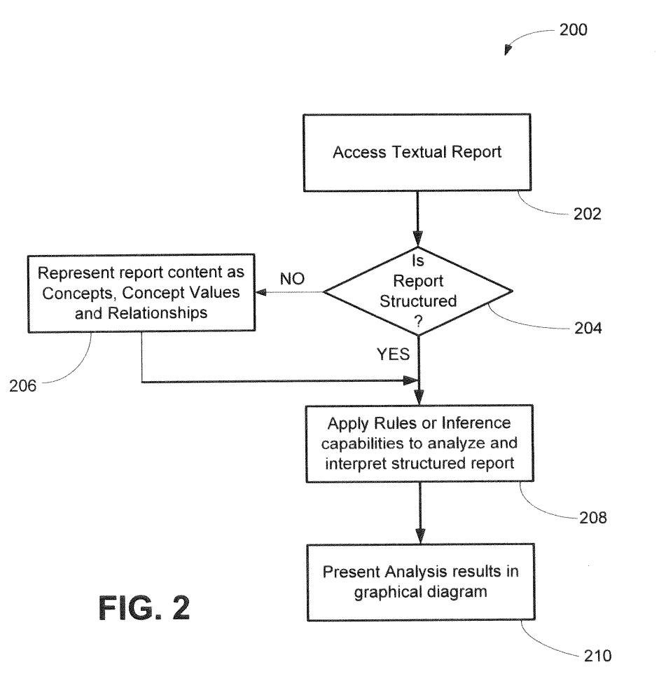

In operation and as illustrated in the flow chart 200 of FIG. 2, the system and method of the present invention may utilize a textual report as input, at step 202. The contents of the textual report include the various studies, findings and comments provided by radiologists or other health care professionals. As would be appreciated by one skilled in the art, the content provided by the textual report may be provided to the system of the present invention in a variety of formats, including spoken words and other input methods, without departing from the spirit or scope of the invention.

At step 204, a determination is made regarding the nature of the content of the textual report. If it is determined that the report was not structured, meaning that the various informational items contained therein are not classified or otherwise correlated, then processing proceeds to step 206. Conversely, if the report content is already structured then processing proceeds to step 208. At step 206, the contents of the report are structured. In other words, in one embodiment of the present invention, the report contents are represented as concepts, concept values and relationships, which may be expressed in ontology.

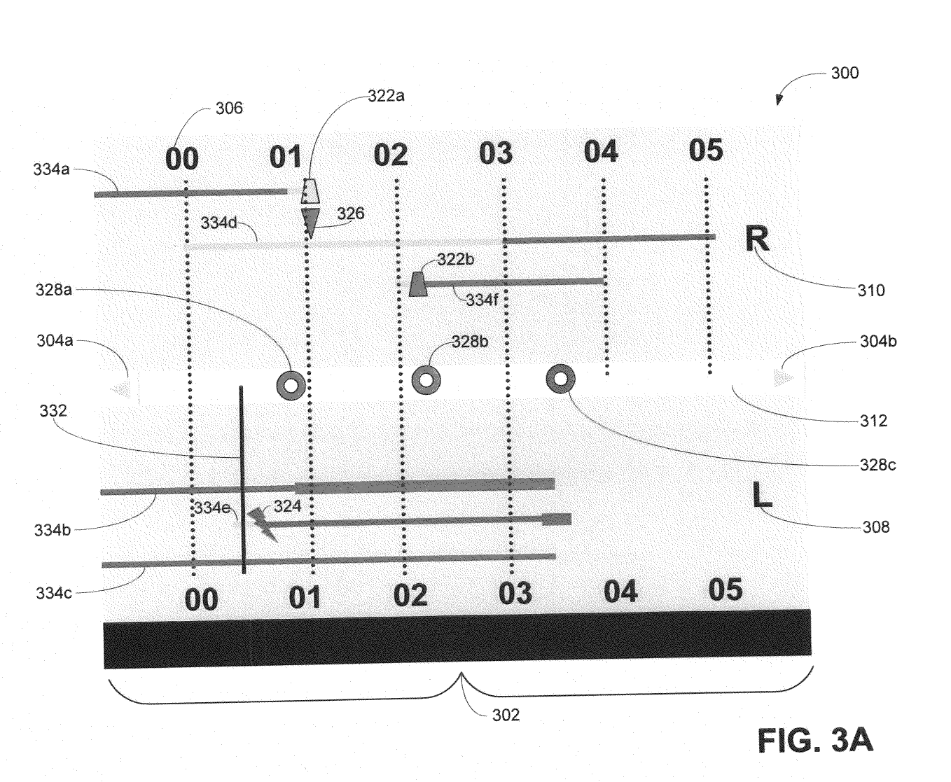

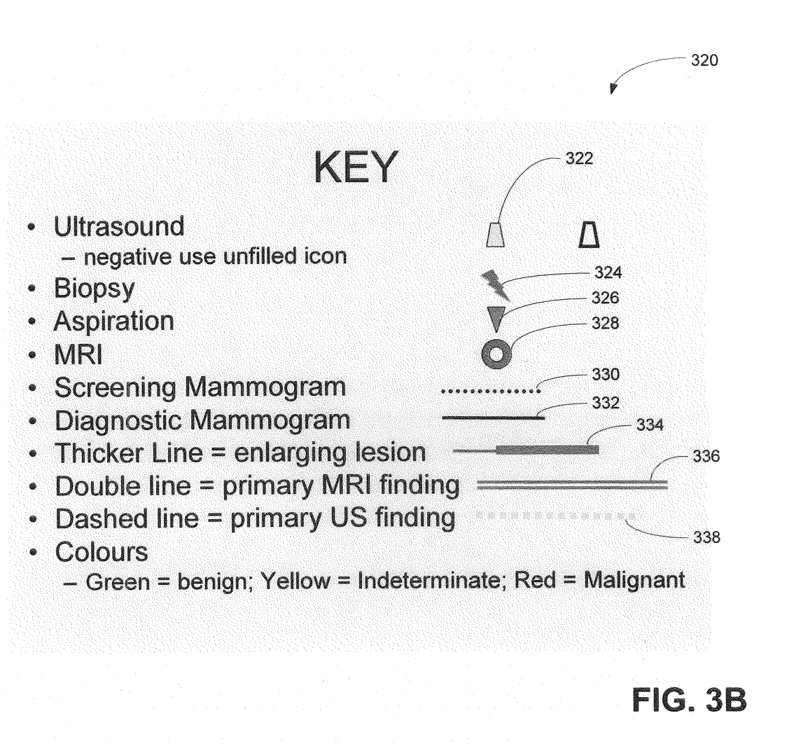

The ontology may contain additional rules or inference capabilities. As such, at step 208, the structured report content is analyzed in the context of rules and inferences for an interpretation of the report. The result of the analysis and interpretation may then be presented in a graphical diagram at step 210. The graphical representation eliminates the need for a reader to go through all of the text of the prose text report and provides report content that is more easily and quickly comprehensible as is apparent in the illustrative example of FIG. 3A.

In connection with a particular image or study that is being observed or considered by a radiologist, there may be a number of findings. Associated with the findings may be further descriptors which thereby define a relationship expressed as an object property for the relevant findings. Consequently, these studies and findings may be presented in a diagram as objects having certain shapes, colors, placement and characteristics.

Attributes within the realm of radiological knowledge including diagnosis, anatomic location, and follow-up recommendation, of pathological, physiological, and iatrogenic entities and pathological, physiological, and iatrogenic observations may be modeled conceptually as radiological finding characteristics whereby a particular one of the findings may be associated with an anatomic location. Further, there may be a follow-up recommendation for any one or more of the findings. Even further, findings may also be associated with a diagnosis.

The modeled ontology may further contain constraints on radiological findings, radiological finding characteristics, and relationships. Further still, the ontology may also contain concept properties, such as applicability to a user interface or application localization, i.e., language indication. It should be understood that certain concepts may be defining concepts from which individual instances may be utilized to represent the vocabulary representing the concept.

The application program of the present invention examines the classification of each piece of information and if one informational item is classified as a mammography radiological finding, then the ontology is consulted in the context of the mammography radiological finding, and the remaining information is revalidated, i.e., verify that the radiological finding characteristics apply to that radiological finding.

These steps result in providing radiological information that has been validated, identified and classified in the mammography domain ontology to other application programs or functions, such as the diagramming application that provides the graphical illustrations of the present invention.

Radiology, which includes a variety of imaging modalities such as, X-ray, Projected X-ray and MRI, comprises of numerous findings plus several hundred characteristics. In the area of mammography, there are approximately fifteen specific findings, in addition to the applicable characteristics for those findings. The present invention, while described in the domain of mammography, is applicable to any domain ontology in the field of radiology.

The graphical presentation of the present invention is best described and understood with reference to FIGS. 3A and 3B. FIG. 3A illustrates a color-coded graphical diagram 300 that represents multiple radiological imaging studies performed on an individual patient. These studies are similar to studies that were set out in the textual report 100 of FIG. 1. FIG. 3B provides a key or legend 320 to the symbols and nomenclature of FIG. 3A, as well as the meaning of the different colors (i.e., red, yellow and green) used therein.

Turning initially to FIG. 3A, contrary to the textual report 100, the graphical diagram 300 provides “at a glance” correlation among events or findings and more clearly identifies findings that persist over time. In an embodiment of the present invention, the graphical diagram 300 provides a time period window 302, having displayed therein approximately a six year time period of patient records—1999 to 2005. The period window 302 is scrollable by use of the arrow icons 304a, 304b to view records from other periods. A marker for each displayed year is provided by a numeric display, such as year display 306 for the year 2000. For ease of reference, the numeric year displays are provided both at the upper and lower regions of the diagram 300. The upper and lower regions of the diagram 300 may also be designated for providing indicia for each of the left breast—“L” 308 and the right breast—“R” 310, as shown. A middle region 312 may also be provided for indicia of studies that would be applicable to both the left and right breasts and the whole body.

For example, a first MRI 328a was performed in the latter half of the year 2000. Since this applies to the entire body, first MRI 328a is shown in the middle region 312. The first MRI 328a is indicated in green thus revealing that the findings were benign. Also shown in region 312 are the multiple MRI studies 328a, 328b, 328c that were performed in late 2000, early 2002 and approximately mid-2003. MRIs 328a, 328b are shown in green, indicating benign findings. The MRI 328c in mid-2003 is shown in red, thus indicating that the findings in that case were determined to be malignant. The symbols, colors and representations of the diagram 300 are best understood by referring to FIG. 3B where a legend 320 is illustrated.

Turning briefly to the legend 320 of FIG. 3B, a variety of symbols are provided to indicate various studies, progressions and status. Colors are also used to indicate characteristics of findings. In an embodiment of the present invention, the legend 320 comprises symbols for ultrasound 322, biopsy 324, aspiration 326, MRI 328, screening mammogram 330, diagnostic mammogram 332, enlarging lesion 334, primary MRI finding 336, and primary ultra sound finding 338. Where applicable, colors are utilized to indicate the characteristics associated with a particular study or finding. The fill status of a symbol also indicates relevant information. In operation, the fill color green is used to indicate a benign characteristic, yellow indicates an indeterminate characteristic, and red indicates a malignant characteristic. An unfilled symbol is used to indicate a negative result. Consequently, by combining the various colors, symbols and fill states, a patient history can be presented in the graphical diagram 300.

Returning to FIG. 3a, the illustrated diagram 300 provides a picture of a patient's radiology image study history. A brief discussion of the illustrated information will provide a further understanding of the novelty and unique features of the present invention. Starting on the left side of the diagram 300 and moving toward the right, one can walk chronologically though the patient's history over the course of the period from approximately 1999 to 2005. It should be understood that the characteristics (e.g., benign, indeterminate, malignant) of each of the symbols/lines are color-coded (i.e., green, yellow, red) to graphically display the patient's history.

Beginning just prior to the year 2000 and beyond, the patient is shown to have had a first lesion 334a located in the right breast that was benign. A symbol consistent with the legend 320, lesion line 334a is placed in the region 310 of the diagram 300. Second and third lesions 334b, 334c were located in the left breast, and therefore indicated in the lower region 308 of the diagram 300. In 2000 and basically every year thereafter, a screening mammogram symbol 330 is shown, thus conveying very quickly that a mammogram for screening purposes was conducted yearly. However, a closer look at the position of the screening mammogram shown for the year 2001 reveals that this particular test study was performed probably a few months after the beginning of the year, unlike all the others. Also beginning in the year 2000, and likely as a result of the screening mammogram, a lesion 334d of an indeterminate nature was discovered in the right breast and continued to be assessed in subsequent years. In about mid-2000 a lesion 334e appeared in the left breast and a diagnostic mammogram 332 was conducted of the left breast. Following this a biopsy 324 is shown as being performed with a resulting finding that lesion 334e was malignant. In the later part of the year 2000, an MRI study 328a, was performed. This likely revealed the finding that lesion 334b was enlarging. An enlarging lesion is shown by a thickening of the relevant portion of a lesion line 334 as set forth in the legend 320. Also shown is the fact that lesion 334a in the right breast was reclassified as indeterminate.

In 2001, following the yearly screening mammograms 330, an ultrasound 322a, was conducted of the right breast. The ultrasound 322a was indeterminate as indicated by the solid yellow color of the representative symbol. An aspiration 326 of non-palpable lesions was also conducted on the right breast. The result of the aspiration was that the lesions were benign. Accordingly, the symbol is shown in a solid green. The ultrasound 322a also resulted in a finding that the lesion 334a was no longer present. All other findings from the previous year appear to have remained constant in both breasts and there were no new findings.

In 2002, a screening mammogram 330 and MRI 328b were performed. The screening mammogram revealed another indeterminate lesion 334f in the right breast. An ultrasound 322b of the right breast was therefore conducted and resulted in a finding that the lesion 334f was benign. Meanwhile there was no change with the lesions 334c, 334b, 334c, and 334e.

In 2003, following the yearly screening mammogram 330, lesion 334c is reclassified as benign and shows no enlargement. Lesions 334b, 334c, 334e, and 334f remain unchanged. In mid-2003, an MRI 328c is performed. The MRI 328c results in malignant findings. Further, lesion 334b remains at its previous size, malignant lesion 334e has increased in size and lesion 334c also remained at its previous size. The patient undergoes left mastectomy. The absence of any further symbols in the lower region of the diagram 300, which represents the left breast, conveys the absence/removal of the left breast.

In 2004, screening mammogram 330 is performed. Lesion 334d remains benign and the lesion 334f is no longer present in the right breast. Another screening mammogram 330 performed in 2005 confirms the status of the 2004 findings. No further studies are shown as being performed on the left breast.

The radiological domain ontology declares and fulfills a model of radiological domain knowledge by employing a context that defines a set of domain knowledge and the relationships among said set of domain knowledge with respect to imaging modalities when necessary or appropriate. In other words, this ontology can contain information that is non-modality specific. The invention validates that a report item of interest relating to said imaging modalities is radiological in nature and resides in the domain knowledge. The invention further identifies a definitive concept of said information item from within said domain of knowledge and classifies the information item as a finding or finding characteristic that has object properties. The object properties represent relationships among said findings and finding characteristics. The objects and object properties may then be diagrammatically presented including a plurality of color-coded symbols and/or lines to present a patient's medical history.

Having described the system and method of the present invention and an embodiment thereof, an exemplary computer environment for implementing the described design and execution is presented next.

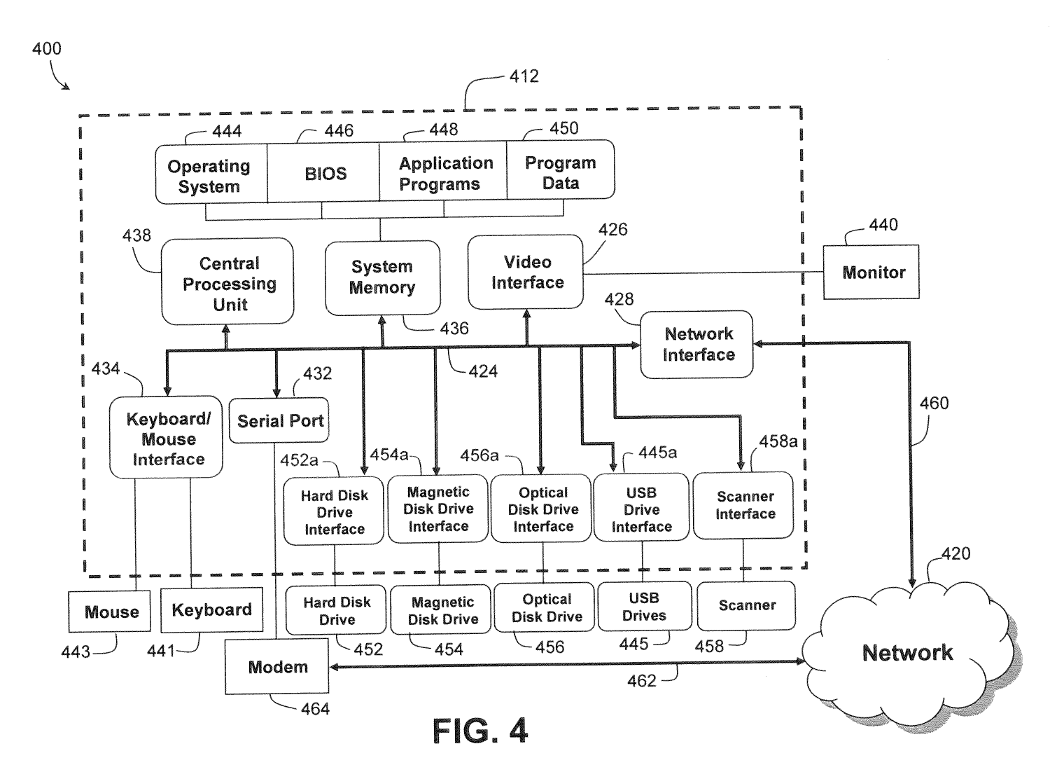

FIG. 4 illustrates an exemplary computing environment 400 that can be used to implement the processing thus far described. The computing environment 40 may comprise a computer 412 including a system bus 424 that couples a video interface 426, network interface 428, one or more serial ports 432, a keyboard/mouse interface 434, and a system memory 436 to a Central Processing Unit (CPU) 438. Computer 412 may also include a Graphics Processing Unit (GPU) or one or more other special or general purpose processing units. A monitor or display 440 is connected to bus 424 by video interface 426 and provides the user with a graphical user interface to view, edit, and otherwise manipulate digital images. The graphical user interface allows the user to enter commands and information into computer 412 using a keyboard 441 and a user interface selection device 443, such as a mouse or other pointing device. Keyboard 441 and user interface selection device 443 are connected to bus 424 through keyboard/mouse interface 434. The display 440 and user interface selection device 443 are used in combination to form the graphical user interface which allows the user to implement at least a portion of the present invention. Other peripheral devices may be connected to computer 412 through serial port 432 or universal serial bus (USB) drives 445 to transfer information to and from computer 412. For example, CT scanners, X-ray devices and the like may be connected to computer 412 through serial port 432 or USB drives 445 so that data representative of a digitally represented still image or video may be downloaded to system memory 436 or another memory storage device associated with computer 412 to enable processes and functions in accordance with the present invention.

The system memory 436 is also connected to bus 424 and may include read only memory (ROM), random access memory (RAM), an operating system 444, a basic input/output system (BIOS) 446, application programs 448 and program data 450. The computer 412 may further include a hard disk drive 452 for reading from and writing to a hard disk, a magnetic disk drive 454 for reading from and writing to a removable magnetic disk (e.g., floppy disk), and an optical disk drive 456 for reading from and writing to a removable optical disk (e.g., CD ROM or other optical media). The computer 412 may also include USB drives 445 and other types of drives for reading from and writing to flash memory devices (e.g., compact flash, memory stick/PRO and DUO, SD card, multimedia card, smart media card), and a scanner 458 for scanning items such as a still image to be downloaded to computer 412. A hard disk interface 452a, magnetic disk drive interface 454a, an optical drive interface 456a, a USB drive interface 445a, and a scanner interface 458a operate to connect bus 424 to hard disk drive 452, magnetic disk drive 454, optical disk drive 456, USB drive 445 and a scanner 458, respectively. Each of these drive components and their associated computer-readable media may provide computer 412 with non-volatile storage of computer-readable instruction, program modules, data structures, application programs, an operating system, and other data for the computer 412. In addition, it will be understood that computer 412 may also utilize other types of computer-readable media in addition to those types set forth herein, such as digital video disks, random access memory, read only memory, other types of flash memory cards, magnetic cassettes, and the like.

Computer 412 may operate in a networked environment using logical connections with image capture devices such as MRI, CT scanners, Ultrasound, Positron Emission Tomography (PET) or X-Ray devices. Network interface 428 provides a communication path 460 between bus 424 and network 420, which allows images to be communicated through network 420 from any of the previously identified imaging devices, and optionally saved in a memory, to the computer 412. This type of logical network connection is commonly used in conjunction with a local area network. Images may also be communicated from bus 424 through a communication path 462 to network 420 using serial port 432 and a modem 464. Using a modem connection between the computer 412 and imaging devices may be used in conjunction with a wide area network or the Internet. It will be appreciated that the network connections shown herein are merely exemplary, and it is within the scope of the present invention to use other types of network connections between computer 412 and imaging devices including both wired and wireless connections.

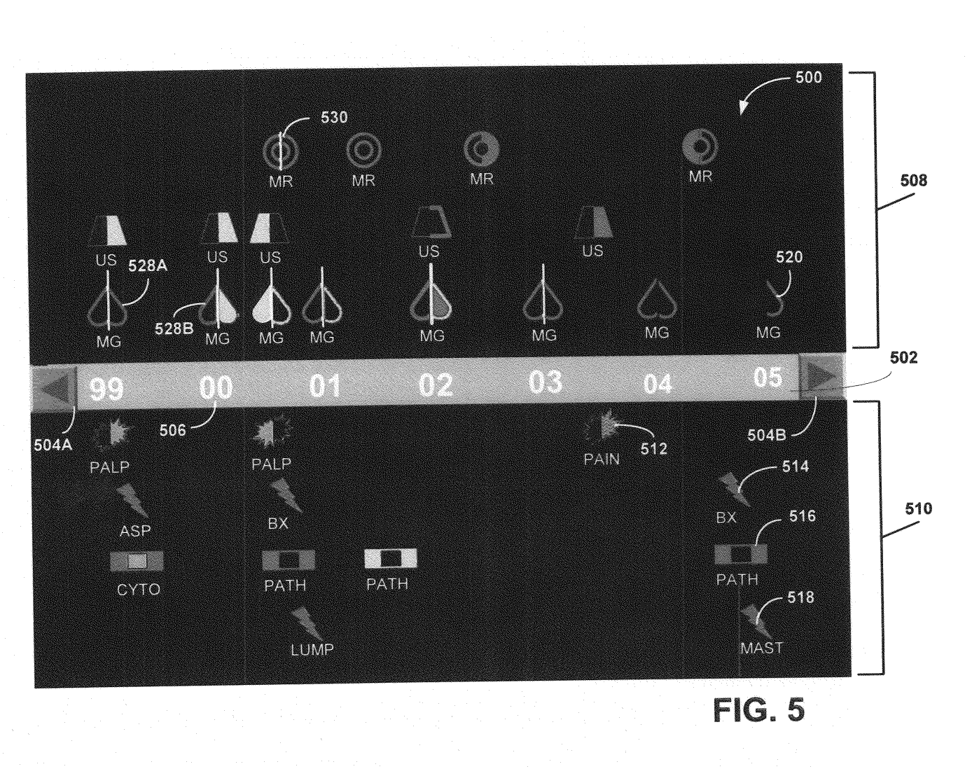

As would be appreciated by one skilled in the art, alternate implementations of the present invention may utilize varied symbolisms and display arrangements as well as, convey additional relevant patient information, without departing from the spirit and scope of the invention. Examples of such alternate embodiments are illustrated in FIGS. 5-9.

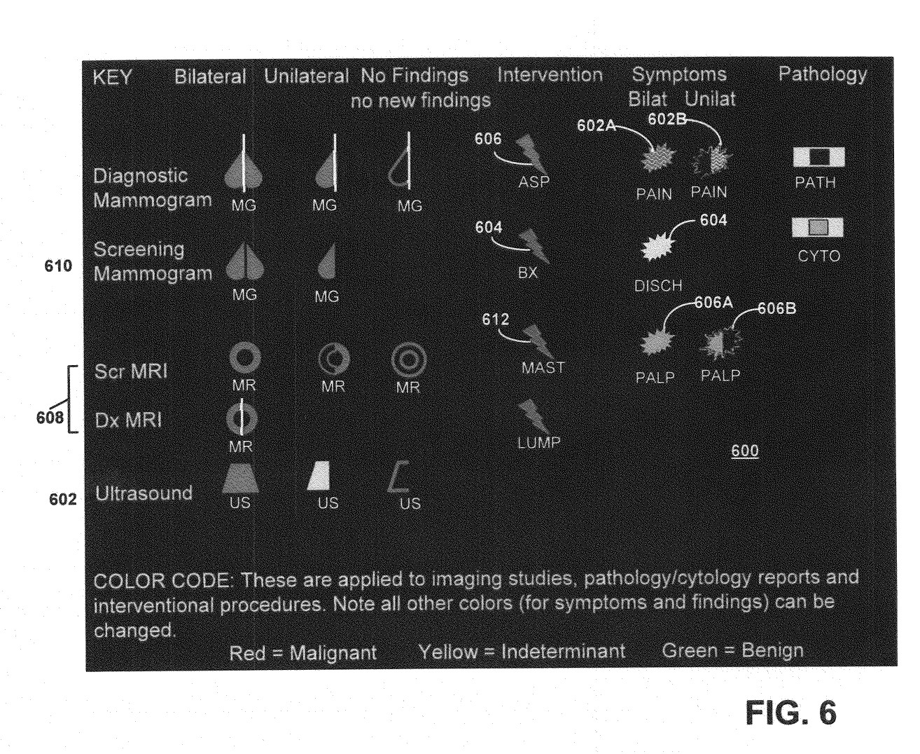

Turning initially to FIG. 5, the graphical diagram 500 provides “at a glance” correlation among events or findings and more clearly identifies findings that persist over time. In an embodiment of the present invention, the graphical diagram 500 provides a time period window 502, having displayed therein approximately a six year time period of patient records—1999 to 2005. The period window 502 is scrollable by use of the arrow icons 504a, 504b to view records from other periods. A marker for each displayed year is provided by a numeric display, such as year display 506 for the year 2000. For ease of reference, the numeric year displays are provided in the middle of the diagram 500 thereby creating two regions for information display. First and second regions 508, 510 of the diagram 500 are designated for providing indicia relating to different aspects of patient information. For example, and as shown, the first region 508 may be utilized to convey modality and imaging related information. The second region 510 may be utilized to convey non-imaging data, such as pathology and technologist identified information (e.g., pain, lump, etc.), or clinical information. Clinical information may include follow-up recommendations, reason for exam, patient signs and symptoms, and patient or family medical history. A variety of symbols and colors are utilized to convey information to a user. Where it is appropriate, a symbol comprises two halves that represent the left and right side of the body (e.g., left breast and right breast). The various symbols, colors and representations of the diagram 500 are best understood by referring to FIG. 6, wherein a legend 600 is illustrated.

Turning briefly to the legend 600 of FIG. 6, a variety of symbols and colors are provided to indicate various studies, findings, progressions and status. In one embodiment of the present invention, the legend 600 comprises symbols for ultrasound 602, biopsy 604, aspiration 606, MRI 608, screening mammogram 610, etc. Where it is applicable, colors are utilized to indicate the characteristics associated with a particular study or finding. The fill status or fill color of a symbol is also utilized to indicate relevant patient information. In operation, a fill color of green is used to indicate a benign characteristic, yellow indicates an indeterminate characteristic, and red indicates a malignant characteristic. An unfilled symbol is used to indicate a negative result. Consequently, by combining the various colors, symbols and fill states, a complete color-coded patient history can be presented for analysis in the graphical diagram 500 of FIG. 5.

For example, returning to FIG. 5, a first diagnostic mammogram 528A was performed in the year 1999. The left and right portions of symbols are not filled, thus indicating no findings of abnormality. In the year 2000 another mammogram 528B was performed. In this particular instance, the left portion of the symbol, which is indicative of the left breast, had no findings. However, on the right side of the symbol (i.e., right breast), an indeterminate mass was found. As such, the right portion of the symbol 528B is displayed with a fill color of yellow.

In mid 2000, symbol 530 conveys that an MRI was conducted. The symbol 530 is divided into two halves to represent the left and right breasts. The presence of a break between the two halves conveys that this was a diagnostic MRI as opposed to a screening MRI. This interpretation is made possible by legend 600 in FIG. 6. Consistent with other embodiments of the present invention, this embodiment also conveys findings through the combination of color, shape, fill color, patterns or other similar visible indications. As shown, the left portion of the MRI 530 is a non-filled semi circle with red lines. According to the legend 600, non-filled semi-circles or circles are indicative of no new findings or no findings, respectively. Also, the color red is indicative of a malignant status and green is indicative of a benign status. As such, it can quickly be deduced from the symbol 530 and its coloring that in the left breast there was a malignant mass discovered by an MRI, with no new findings. Symbol 530 also illustrates that in the right breast there was a benign mass with a negative finding by displaying green lines. Other symbols can be similarly interpreted to deduce historic findings and relevant modalities.

In a further aspect of the present invention, other patient information aside from imaging information may also be reported in the color-coded graphical representation. Such other information includes but is not limited to pathology/cytology reports, symptoms and intervention procedures. Legend 600 provides an additional number of exemplary clinical information symbols including symbols for symptoms, such as pain 602A, 602B, discharge 604, and PALP 606A, 606B any of which may be bilateral or unilateral. Color-coded symbols are also provided to represent treatment interventions such as mastectomy 612, biopsy 604, etc.

Returning to FIG. 5, the second region 510 may be utilized to convey these non-imaging information. For example, symbol 512 conveys that in mid-2003, the patient complained of pain on the right side. From mid-2004 till the tail end of 2004, the patient underwent a biopsy 514, a pathology 516 and a mastectomy 518.

Consequently, the indicated green-colored symbol 520 of a screening mammogram conducted in 2005, indicates findings for a right breast only. A detailed status and patient history is thus conveyed through the color-coded graphical presentation. Importantly, the patient history and status can be quickly and easily understood and assimilated by medical personnel irregardless of the language spoken by the medical personnel. In other words, the graphical presentation is language independent.

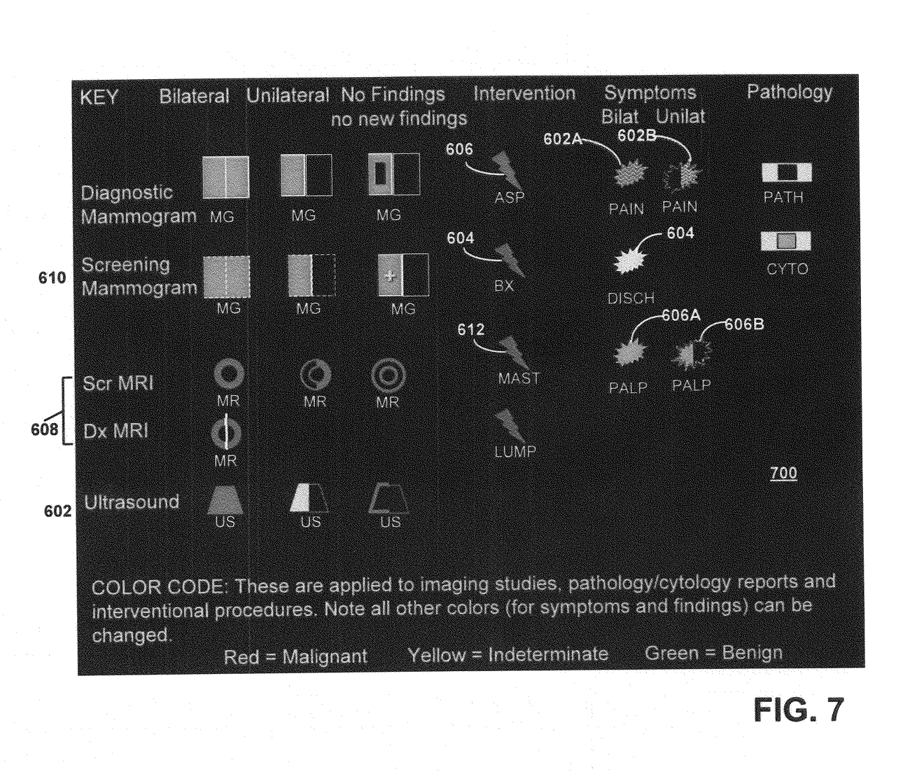

As previously stated, there can be numerous variations in the presentation and representation of modalities, interventions, patient information etc. In an alternate embodiment of the present invention, diagnostic and screening mammogram information may be related to users utilizing a myriad of other symbols. One set of such symbols is illustrated in legend 700 of FIG. 7.

The present invention further provides end users with the ability to customize the graphical display of information by the configuration and/or selection of symbols, presentation styles and colors.

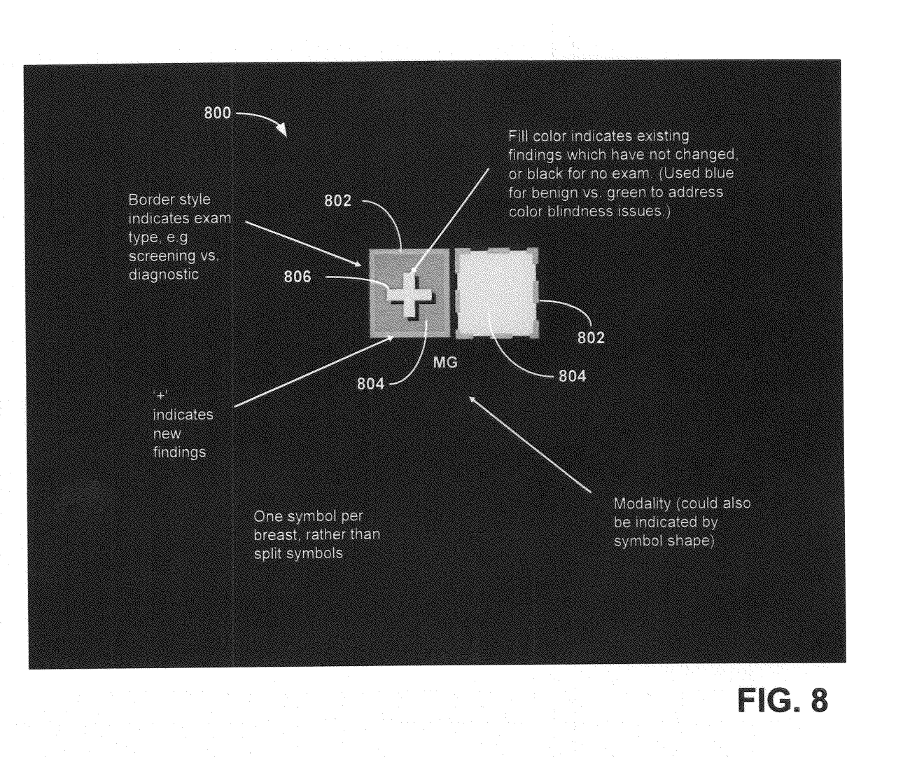

In a further embodiment of the present invention, a symbol 800 shown in FIG. 8 is utilized to convey information and details regarding a modality. As shown in this illustration, symbol 800 comprises one symbol per breast rather than a split symbol. Importantly, symbol 800 enables an increase in the number of information items that are conveyed to a user compared to the previously described symbols. Symbol 800 provides variations of visual attributes in addition to color to convey information items.

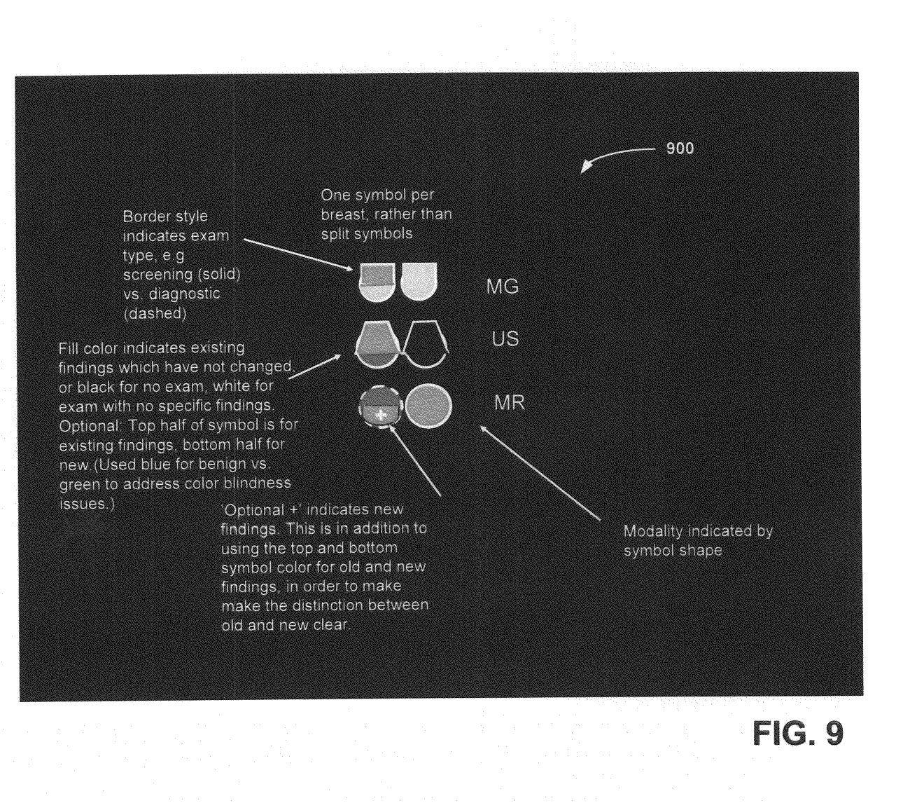

For example, the line-style of border 802 is utilized to indicate an examination type such as, screening versus diagnostic. The shape of the symbol indicates modality. The fill color 804 of the symbol represents existing findings, which have not changed. The absence of a fill color indicates the absence of a finding. A plus-sign 806 or other markings may be presented within the borders of the symbol 800 to indicate new findings and attributes associated therewith. The plus-sign 806 may include a fill color to indicate details of the new finding (e.g., benign, malignant, indeterminate). In a further aspect of the invention, the colors of the various markings, symbols, fills, borders and/or background are selectable by an end user of the system and adjustable by the system to address issues relating to color blindness. For example, a blue fill color 804 may be utilized rather than green to represent a benign finding, since this would be discernable by a color blind individual. As previously mentioned, the present invention provides a number of variations in symbols, color schemes, markings, shapes, texture and orientation to convey patient information. FIG. 9 illustrates a further set of representation symbols 900 that may be utilized in other embodiments of the present invention.

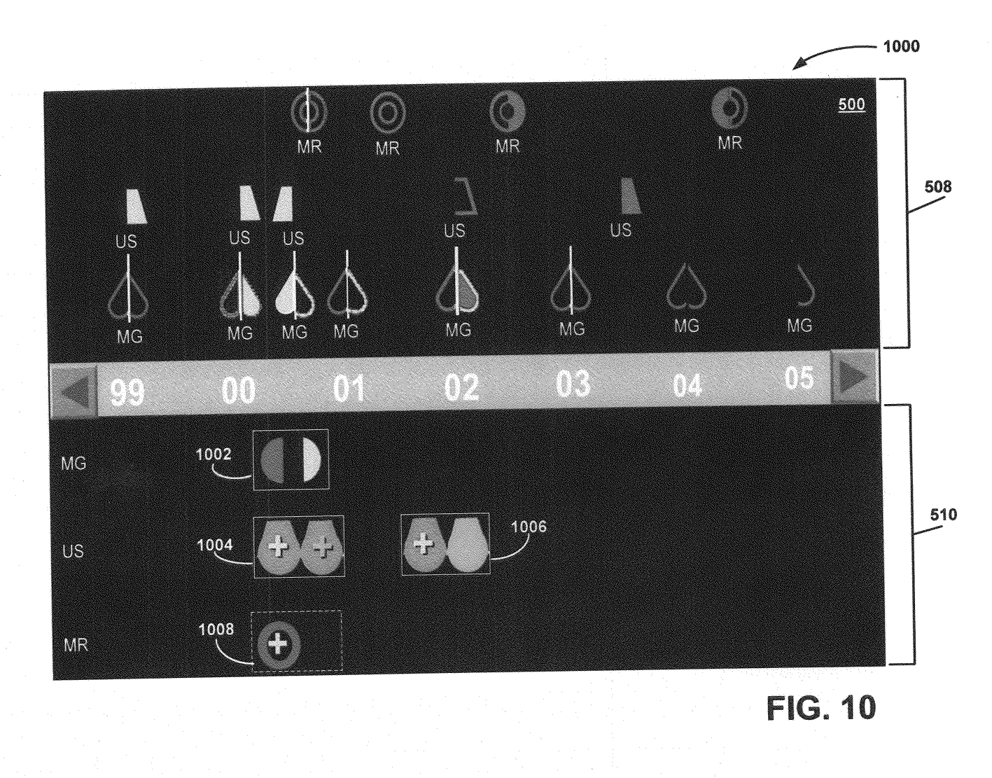

Turning to FIG. 10, a screen display of yet another aspect of the present invention is presented. As previously mentioned, the regions of the graphical diagram 500 may be used to display varied information. The second region 510 herein is utilized to convey summary information grouped by modality. For example, one can quickly determine that the patient has undergone one mammogram 1002, two ultrasound tests 1004, 1006 and one MRI 1008. The findings and finding characteristics in each case are also provided, as shown. Importantly, the reports/symbols from these historic studies are placed side-by-side to facilitate comparison and quick discernment of differences.

The present invention provides a useful, novel and non-obvious means to utilize an ontology of radiological knowledge to interpret report content and generate information to be displayed in a graphical diagram. Additionally, the present invention provides a tool that may be utilized by other applications or systems as a building block for further information processing.

From the foregoing, it will be seen that this invention is one well adapted to attain all the ends and objectives hereinabove set forth together with other advantages which are obvious and which are inherent to the method and apparatus. It will be understood that certain features and sub-combinations are of utility and may be employed without reference to other features and sub-combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. As used herein, the terms “having” and/or “including” and other terms of inclusion are terms indicative of inclusion rather than requirement.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed, as the best mode contemplated for carrying out this invention, but that the invention will include all embodiments falling within the scope and spirit of the appended claims.

What is claimed is:

1. A method programmed in a computing environment for graphically presenting aspects and contents of a patient's records, the records including reports of multiple studies, the method comprising:
obtaining a textual report of said patient's studies;
performing an analysis of said textual report to provide a structured report that identifies and classifies said textual report's content by representing said textual report's content as sets of concepts, concept values and relationships;
analyzing and interpreting said structured report; and
presenting the result of the analysis of said structured report in a graphical diagram;
said graphical diagram utilizing one or more symbols to represent the content of said structured report;
said textual report having content, comprising:
an identification of the types of studies conducted; and
a timestamp for when said studies were performed.

2. The method of claim 1 wherein each of said one or more symbols comprises:
one or more geometric shapes;
one or more line colors; and
one or more fill colors;
said one or more geometric shapes identifying particular modalities;
said one or more fill colors conveying a current status;
said one or more line colors conveying a prior status;
wherein for said one or more fill or line colors a first color conveys malignant status, a second color conveys indeterminate status, and a third color conveys benign status, said fill colors further including a fourth color to convey negative result.

3. The method of claim 2, wherein particular ones of said one or more symbols comprise first and second portions.

4. The method of claim 3, wherein said first and second portions represent left and right halves respectively.

5. The method of claim 3, wherein said first and second portions represent existing and new findings respectively.

6. The method of claim 2, wherein said one or more geometric shapes provides an indication of a bilateral or unilateral result.

7. The method of claim 2, wherein said one or more symbols further comprises a border style for indicating an exam type for a given modality.

8. The method of claim 7, wherein said exam type is a screening or diagnostic.

9. The method of claim 2, wherein said one or more symbols further comprises a secondary symbol located within the boundaries of said one or more symbols.

10. The method of claim 9, wherein said secondary symbol indicates the presence of a new finding.

11. The method of claim 1 wherein said textual report content further comprises one or more findings from said studies.

12. The method of claim 1 wherein said textual report content further comprises one or more follow-up recommendations of said studies.

13. The method of claim 11 wherein said textual report content further comprises one or more impressions of said finding.

14. The method of claim 1 wherein the patient report comprises:
reason for an exam; and
patient signs and symptoms.

15. The method of claim 14 wherein said textual report further comprises patient or family medical history.

16. The method of claim 1 wherein said performing of an analysis of said textual report to provide a structured report that identifies and classifies said textual reports' content, is expressed in ontology.

17. The method of claim 1 wherein the analysis and interpretation of said structured report further comprises utilizing rules or inference capabilities and ontology.

18. The method of claim 1 further comprising validating that said textual report content is within a specific radiological context.

19. The method of claim 16 wherein said ontology is a radiological domain ontology.

20. The method of claim 19 further comprising adding a new radiological concept as an instance or instance expression to said radiological domain ontology.

21. The method of claim 19 further comprising deleting an instance or instance expression of an existing radiological concept from said radiological domain ontology.

22. The method of claim 16 wherein said analysis of said textual report to provide a structured report comprises:
defining one or more textual report content items as concept properties represented by a vocabulary of one or more instances of a radiological domain ontology, said radiological domain ontology declaring and fulfilling a model of radiological domain knowledge;
evaluating a report content item;
employing a context that defines a set of said domain knowledge and the relationships among said set of domain knowledge to describe said report item;
validating said report item is radiological and resides in said radiological domain of knowledge;
identifying a definitive concept of said report item from within said radiological domain of knowledge; and
classifying said report item;
wherein said model of radiological domain knowledge comprises:
one or more findings;
one or more finding characteristics; and
object properties, wherein said object properties represent relationships among said findings and finding characteristics.

23. The method of claim 22 wherein said classifying identifies or defines said report item as a finding or finding characteristic.

24. A method programmed in a computing environment for providing a graphical presentation in a single diagram of the contents of a report on radiological image examinations, the method comprising:
obtaining a prose text report or a structured report of said radiological image studies, said prose text or structured report having content comprising:
an identification of each type of said radiological image examination;
a timestamp for when each of said radiological image examination was performed;
analyzing said prose text report or said structured report;
providing a second structured report from said prose text report wherein, the prose text report content are represented in said second structured report as sets of concepts, concept values and relationships;
applying rules or inference capabilities to analyze the applicable one of said structured report and said second structured report; and
presenting a graphical representation of the applicable one of said structured report and said second structured report.

25. The method of claim 24 wherein said prose text or structured report content further comprises a finding from said examination.

26. The method of claim 25 wherein said prose text or structured report content further comprises a follow-up recommendation of said examination.

27. The method of claim 26 wherein said prose text or structured report content further comprises a conclusion of said examination.

28. A method programmed in a computing environment for providing a single graphical diagram to present the contents of a plurality of radiological image studies, the method comprising:
obtaining a report of said radiological image studies, each of said image studies characterized by at least a time stamp, an image study type and findings provided by a radiologist during the process of analyzing the image that was the subject of said image study;
utilizing an ontology of radiological domain knowledge to interpret said image studies and to generate one or more informational items for display; and
providing in said graphical diagram, said one or more informational items for display.

29. The method of claim 28 wherein said one or more informational items comprises the characteristics of said image studies.

30. The method of claim 28 wherein said one or more informational items includes the characteristics of said image studies.

31. The method of claim 28, wherein said one or more information items further comprises an evolution of image study findings over time.

32. The method of claim 28, wherein said one or more informational items further comprises an indication of the clinical significance of image study findings.

33. The method of claim 28, wherein the step of utilizing an ontology of radiological domain knowledge to interpret image studies comprises:
modeling image studies as:
one or more findings;
one or more finding characteristics; and
object properties, wherein said object properties represent relationships among said findings and finding characteristics.

34. A method programmed in a computing environment for providing a single graphical diagram to present clinical data content of a patient's records, the method comprising:
obtaining a report of the patient's records, each of said clinical data characterized by at least a time stamp and identification of a clinical process provided by a pathologist or technologist;
interpreting said patient's records to generate one or more informational items for display;
said one or more informational items comprising the characteristics of said clinical process; and
providing in the graphical diagram, at least one symbol to represent said one or more informational items and the characteristics of said clinical process.

35. The method of claim 34 wherein said clinical data content is a record of pain reported by the patient.

36. The method of claim 34, wherein said clinical data content is the presence of a lump in the patient.

37. The method of claim 34, wherein said clinical data content is a biopsy record.

38. The method of claim 34, wherein said symbol comprises:
a geometric shape; and
one or more fill colors;
said geometric shape identifying a particular symptom; and
said one or more fill colors conveying one or more modes for determining said particular symptom.
